(19) United States
(12) Patent Application Publication
(10) Pub. No.: US 2025/0132686 A1
(43) Pub. Date: Apr. 24, 2025

(54) Multi-Phase Resonant Power Converter

(71) Applicant: Infineon Technologies Austria AG, Villach (AT)

(72) Inventors: Jonas Emanuel Huber, Aarau (CH); David Menzi, Burgdorf (CH); Johann Walter Kolar, Zurich (CH); Matthias Joachim Kasper, Villach (AT); Gerald Josef Deboy, Klagenfurt (AT)

(21) Appl. No.: 18/491,198

(22) Filed: Oct. 20, 2023

(51) Int. Cl. H02M 3/335; H02M 1/088; H02M 3/00

(52) U.S. Cl. CPC H02M 3/33584; H02M 1/088; H02M 3/01; H02M 3/33573

(57) ABSTRACT

A multi-phase resonant power converter includes: a power stage on a primary side of the multi-phase resonant power converter, the power stage including bridge converter legs each configured to receive an AC input voltage and implement a separate phase of the power converter; a transformer device having a primary side winding for each bridge converter leg and a secondary side winding for each primary side winding; a power circuit electrically connected to the secondary side windings on a secondary side of the multi-phase resonant power converter; a primary-side controller configured to operate the bridge converter legs at a switching frequency; and a separate resonant tank electrically connected to a midpoint of each bridge converter leg. Each resonant tank includes a resonant capacitor in series with the primary side winding for that bridge converter leg. A resonant frequency of each resonant tank is tuned to within +/−50% of the switching frequency.

### BACKGROUND

Most commercially available isolated three-phase power converters typically comprise a non-isolated PFC (power factor correction) rectifier front-end, and require a second stage on the primary side for DC-DC conversion and isolation. A relatively new branch of research is the topic of single-stage three-phase isolated converters that are designed for direct connection to the grid. However, single-stage three-phase isolated converters typically require 1200V rated bidirectional switch devices and feature either a complicated control concept or a fixed output voltage. Phase-modular solutions utilize 600V/650V rated bidirectional switch devices on the primary side but require a larger number (3×4) bidirectional switch devices and the current circulating through the transformers and the switches is always determined by the grid phase carrying the highest current. Even if a phase is instantaneously providing a low level of power (e.g. around the zero crossing of the grid period), the switch devices and the transformer winding for this phase still must carry the same current as during the peak of the grid period which is inefficient.

Thus, there is a need for an improved multi-phase resonant power converter.

### SUMMARY

According to an embodiment of a multi-phase resonant power converter, the multi-phase resonant power converter comprises: a power stage on a primary side of the multi-phase resonant power converter, the power stage comprising a plurality of bridge converter legs each configured to receive an AC input voltage and implement a separate phase of the multi-phase resonant power converter; a transformer device having a primary side winding for each bridge converter leg of the power stage, and a secondary side winding for each primary side winding; a power circuit electrically connected to the secondary side windings of the transformer device on a secondary side of the multi-phase resonant power converter; a primary-side controller configured to operate the bridge converter legs of the power stage at a switching frequency; and a separate resonant tank electrically connected to a midpoint of each bridge converter leg of the power stage, each resonant tank comprising a resonant capacitor in series with the primary side winding for that bridge converter leg, wherein a resonant frequency of each resonant tank is tuned to within +/−50% of the switching frequency.

According to an embodiment of a method of operating the multi-phase resonant power converter, the method comprises: applying an AC input voltage to the bridge converter legs of the power stage; operating the bridge converter legs of the power stage at a switching frequency; and selecting the switching frequency such that a resonant frequency of each resonant tank is tuned to within +/−50% of the switching frequency.

According to another embodiment of a multi-phase resonant power converter, the multi-phase resonant power converter comprises: a plurality of primary-side bridge converter legs on a primary side of the multi-phase resonant power converter, each primary-side bridge converter leg configured to receive an AC input voltage and implement a separate phase of the multi-phase resonant power converter; a plurality of secondary-side bridge converter legs on a secondary side of the multi-phase resonant power converter, each secondary-side bridge converter leg configured to implement a separate phase of the multi-phase resonant power converter; a transformer device having a primary side winding for each primary-side bridge converter leg and a secondary side winding for each secondary-side bridge converter leg; at least one controller configured to operate the secondary-side bridge converter legs and the primary-side bridge converter legs at a switching frequency; and a separate resonant tank electrically connected to a midpoint of each secondary-side bridge converter leg, each resonant tank comprising a resonant capacitor in series with the secondary side winding for that secondary-side bridge converter leg, wherein a resonant frequency of each resonant tank is tuned to within +/−50% of the switching frequency.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a schematic diagram of a multi-phase resonant power converter, according to an embodiment.

FIG. 2 represents a 3-phase voltage system as transferred into a stationary reference frame (alpha-beta).

FIG. 3 illustrates primary-side and secondary-side voltages, respectively, of a transformer device of the multi-phase resonant power converter with the resonant tanks of the multi-phase resonant power converter generically represented as a single tank. FIG. 3 also illustrates a SVM (space vector modulation) control scheme for the switch devices of a secondary-side power circuit.

FIG. 4 illustrates simulation results for the multi-phase resonant power converter operated in boost mode, over a mains cycle and for a target output voltage of 500V.

FIG. 5 illustrates a time-zoomed view of FIG. 4.

FIG. 6 illustrates the same waveforms as FIG. 4, but for a simulation of the multi-phase resonant power converter operated in buck mode and for a target output voltage of 200V.

FIG. 7 illustrates a time-zoomed view of FIG. 6.

FIG. 8 illustrates an embodiment of the multi-phase resonant power converter where the AC input voltage has a single phase.

FIG. 9 illustrates a SVM control scheme that creates a hexagon pattern of voltage vectors in the alpha-beta plane with voltage amplitudes proportional to the single AC input voltage. FIG. 9 also shows a single phase of the AC input voltage over time.

FIG. 10 illustrates simulation results for the multi-phase resonant power converter embodiment of FIG. 8, over a mains cycle and for a target output voltage of 400V.

FIG. 11 illustrates a time-zoomed view of FIG. 10.

FIG. 12 illustrates the multi-phase resonant power converter, according to another embodiment.

FIG. 13 illustrates the multi-phase resonant power converter, according to another embodiment.

FIG. 14 illustrates the multi-phase resonant power converter, according to another embodiment.

FIG. 15 illustrates the multi-phase resonant power converter, according to another embodiment.

FIG. 16 illustrates the multi-phase resonant power converter, according to another embodiment.

FIG. 17 illustrates a schematic diagram of a power circuit on the secondary side of the multi-phase resonant power converter, according to another embodiment.

FIG. 18 illustrates a schematic diagram of the power circuit a on the secondary side of the multi-phase resonant power converter, according to another embodiment.

FIG. 19 illustrates a schematic diagram of the power circuit on the secondary side of the multi-phase resonant power converter, according to another embodiment.

FIG. 20 illustrates a schematic diagram of the power circuit on the secondary side of the multi-phase resonant power converter, according to another embodiment.

FIG. 21 illustrates a schematic diagram of the power circuit on the secondary side of the multi-phase resonant power converter, according to another embodiment.

FIG. 22 illustrates simulation results for the diode rectifier power circuit embodiment of FIG. 21, over a mains cycle and for a target output voltage of about 480V.

FIG. 23 illustrates a time-zoomed view of FIG. 22.

FIG. 24 illustrates the multi-phase resonant power converter, according to another embodiment.

FIG. 25 illustrates a schematic diagram of the transformer device of the multi-phase resonant power converter, according to another embodiment.

FIG. 26 illustrates the transformer device, according to another embodiment.

### DETAILED DESCRIPTION

Described herein are circuit, topology, and control embodiments for an isolated resonant power converter that is phase modular, bidirectional, and has a single power stage on the primary side of the converter. The single primary-side power stage includes a plurality of bridge converter legs each configured to receive an AC input voltage and implement a separate phase of the multi-phase resonant power converter. A transformer device galvanically isolates (i.e., no direct conduction path) the primary and secondary sides of the multi-phase resonant power converter. The transformer device has a primary side winding for each bridge converter leg of the primary-side power stage, and a secondary side winding for each primary side winding. An active or passive power circuit on the secondary side of the multi-phase resonant power converter is electrically connected to the secondary side windings of the transformer device and outputs a DC voltage.

A separate resonant tank is provided on the primary or secondary side for each phase of the multi-phase resonant power converter. For example, if implemented on the primary side, a separate resonant tank is electrically connected to a midpoint of each bridge converter leg of the power stage, with each resonant tank having a resonant capacitor in series with the primary side winding for that bridge converter leg. If instead implemented on the secondary side, a separate resonant tank is electrically connected to a midpoint of each secondary-side bridge converter leg, with each resonant tank having a resonant capacitor in series with the secondary side winding for that secondary-side bridge converter leg. For both the primary and secondary side implementations, the resonant frequency of each resonant tank is tuned to within +/−50% of the switching frequency at which the bridge converter legs of the primary-side power stage are operated. The switching frequency may be constant or variable.

The power converter circuit, topology, and control embodiments described herein provide high frequency isolation, support switching with ZVS (zero-voltage switching) on the primary side, enable synchronous rectification and bidirectional power flow, support output voltage regulation, provide PFC (power factor correction) functionality, have low control complexity, require fewer primary-side switch devices (e.g., only 6×600/650V bidirectional switch devices), can operate with a fixed switching frequency, offer single and multi-phase interoperability, and allow for integration of separate high frequency transformers into a single magnetic device. Other advantages will become apparent as the various embodiments are described below in more detail.

Described next, with reference to the figures, are exemplary embodiments of the power converter circuit, topology, and control embodiments.

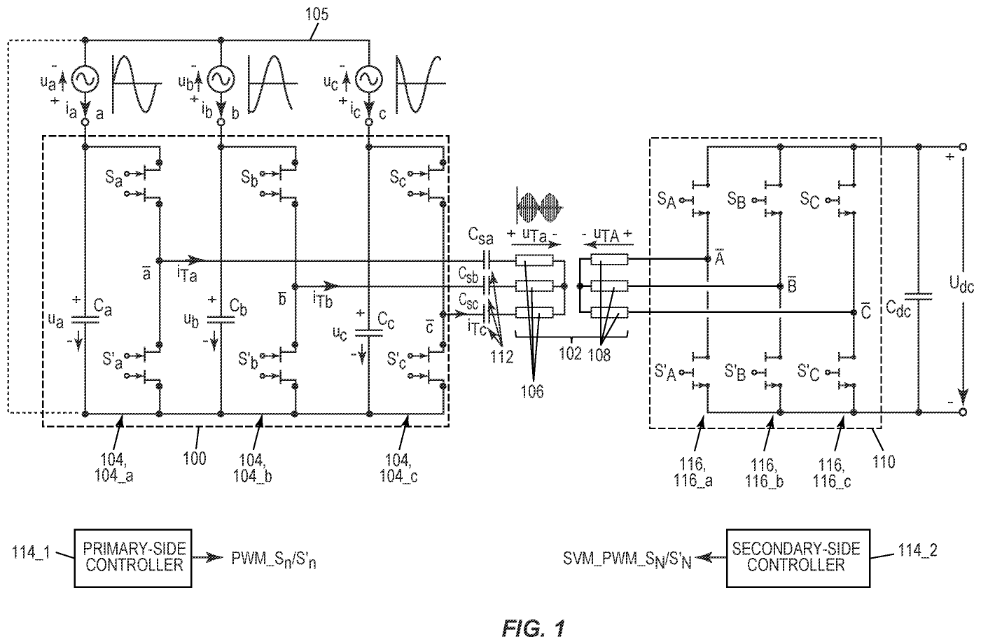

FIG. 1 illustrates a schematic diagram of a multi-phase resonant power converter, according to an embodiment. The multi-phase resonant power converter includes a power stage 100 on the primary side of the multi-phase resonant power converter. A transformer device 102 galvanically isolates (i.e., no direct conduction path) the primary and secondary sides of the multi-phase resonant power converter. The transformer device 102 may be implemented as discrete high frequency transformers with separate magnetic devices, or as separate high frequency transformers integrated into a single magnetic device.

The power stage 100 has a plurality of bridge converter legs 104 each configured to receive an AC input voltage U_{abc} such as an AC grid voltage, and implement a separate phase of the multi-phase resonant power converter. In FIG. 1, each bridge converter leg 104 of the primary-side power stage 100 is a half bridge converter leg that includes an actively controlled leg formed by two power switch devices Sₙ, S′ₙ electrically connected in series at a midpoint n of the bridge converter leg 104, where the subscript ‘n’ indicates phase number on the primary side and the capital subscript ‘N’ indicates phase number on the secondary side. A capacitive leg Cn is in parallel with each actively controlled bridge converter leg 104. In one embodiment, the power switch devices Sₙ, S′ₙ each have a voltage rating defined by the corresponding phase-to-neutral voltage of the AC input voltage U_{abc} instead of the line-to-line voltage which can be 600V, for example.

The transformer device 102 has a primary side winding 106 for each bridge converter leg 104 of the primary-side power stage 100, and a secondary side winding 108 for each primary side winding 106. A power circuit 110 is electrically connected to the secondary side windings 108 of the transformer device 102 on the secondary side of the multi-phase resonant power converter. The power circuit 110 outputs a DC voltage U_{dc} across an output capacitor C_{dc}, where the DC voltage U_{dc} may be larger (in boost mode) or lower (in buck mode) than the line-to-line voltage U_{LLs} of the transformer device 102 on the secondary side, depending on the primary-side control mode.

A separate resonant tank 112 is electrically connected to the midpoint n of each bridge converter leg 104 of the primary-side power stage 100 in FIG. 1. Each resonant tank 112 includes a resonant capacitor Cₛₙ in series with the primary side winding 106 for that bridge converter leg 104.

A primary-side controller 114_1 receives measurement inputs (not shown) such as current measurements, voltage measurements, etc. and operates the bridge converter legs 104 of the primary-side power stage 100 at a switching frequency which may be constant or variable. The resonant capacitor Cₛₙ of each resonant tank 112 is selected/sized such that the resonant frequency of each resonant tank 112 is tuned to within +/−50% of the switching frequency at which the primary-side controller 114_1 operates the bridge converter legs 104 of the power stage 100. The resonant frequency of each resonant tank 112 is determined by the size of resonant capacitor Cₛₙ and the leakage inductance of the transformer device 102. Accordingly, the resonant capacitor Cₛₙ of each resonant tank 112 is selected/sized to be much different than a conventional low frequency AC blocking capacitor that is selected/sized to prevent transformer saturation. This means that the resonant capacitor Cₛₙ of each resonant tank 112 has a capacitance value that is an order of magnitude (or more) different than that of conventional low frequency AC blocking capacitors.

In the case of a constant or variable switching frequency used by the primary-side controller 114_1 and since the AC input voltage U_{abc} changes at low frequency, e.g., 50 to 60 Hz for mains (power line) electricity, each phase applies an approximately (quasi) rectangular voltage to the corresponding resonant tank 112 which has the envelope of the AC input voltage U_{abc}. The voltage envelope is shown in FIG. 1 for the resonant tank 112 that supports the first (‘a’) phase.

Also in FIG. 1, the power circuit 110 on the secondary side has an actively switched half bridge rectification leg 116 for each phase of the multi-phase resonant power converter, where the subscript ‘N’ indicates phase number on the secondary side. Each actively switched half bridge rectification leg 116 on the secondary side includes a pair of power switch devices S_{N}, S′_{N} electrically connected in series at a midpoint N of the actively switched half bridge rectification leg 116, with the corresponding secondary side winding 108 of the transformer device 102 electrically connected to the midpoint N. The half bridge rectification legs 116 are electrically connected in parallel to form a single DC output U_{dc} of the secondary-side power circuit 110.

The power switch devices Sₙ, S′ₙ included in the primary-side power stage 100 may be bidirectional (dual-gate) power switch devices such as bidirectional GaN switch devices and the power switch devices S_{N}, S′_{N} included in the secondary-side power circuit 110 may be unidirectional (single-gate) devices such as power MOSFET (metal-oxide-semiconductor field-effect transistor), IGBT (insulated gate bipolar transistor) or unidirectional GaN devices. The primary-side power switch devices Sₙ, S′ₙ may have a voltage rating of 600V/650V, for example. Depending on the output voltage U_{dc}, the secondary-side power switch devices S_{N}, S′_{N} may be 600V or 1200V rated devices, for example.

The switch devices S_{N}, S′_{N} of the secondary-side power circuit 110 are controlled by space-vector control or duty cycle control to apply a voltage on the secondary side of the transformer device 102, such that resonant currents are seen in the transformer device 102 and a certain power level is transferred from each phase, thus providing PFC functionality. Since PFC functionality is provided by generating resonant or quasi-resonant currents in the transformer device 102 and transferring a certain power level from each phase, a separate PFC stage is not required. Hence, the use of a single power stage 100 on the primary side of the multi-phase resonant power converter. An EMI (electromagnetic interference) filter stage (not shown in FIG. 1) may be placed between the primary-side power stage 100 and the grid that provides the AC input voltage U_{abc}.

In the case of boost operation, the primary-side controller 114_1 operates the primary-side power stage 100 without pulse skipping such that the DC output voltage U_{dc} is higher than the line-to-line voltage u_{LLs} of the transformer device 102 on the secondary side. In the case of buck operation, the primary-side controller 114_1 operates the primary-side power stage 100 with pulse skipping which still provides resonant or quasi-resonant transformer currents iTₐ, iT_{b}, iT_{c}, but causes the DC output voltage U_{dc} to be lower than the line-to-line voltage U_{LLs} of the transformer device 102 on the secondary side. PFC functionality arises because the secondary-side power circuit 110 is operated in a way that correctly adjusts the amplitudes of the resonant pulses over a grid/AC mains period to follow a sinusoidal envelope, such that together with the sinusoidal envelope of the transformer voltages, a sin²-shaped power is drawn from each phase of the AC input.

In FIG. 1, the resonant converter topology utilizes a Y-connection of the bridge converter legs 104 on the primary side and the Y-connection can be attached to the grid neutral conductor 105. With such a Y-connection, the power switch devices Sₙ, S′ₙ on the primary side must only block the line-to-neutral AC input voltage. The actively switched half bridge rectification legs 116 on the secondary side also may be connected in a Y-configuration, as shown in FIG. 1. More generally, the bridge converter legs 104 of the primary-side power stage 100 may be connected to the primary side windings 106 of the transformer device 102 in a Y-configuration, a delta-configuration or a star-configuration, and the rectification legs 116 of the secondary-side power circuit 110 may be connected to the secondary side windings 108 of the transformer device 102 in a Y-configuration, a delta-configuration, or a star-configuration. The connection configurations on the primary and secondary sides of the multi-phase resonant power converter may be of the same type or different.

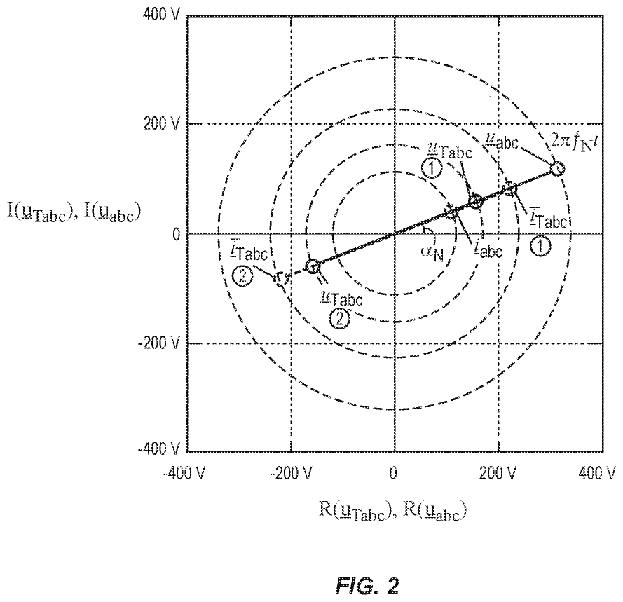

Operation of the multi-phase resonant power converter shown in FIG. 1 is described next in more detail with reference to FIGS. 2 through 7.

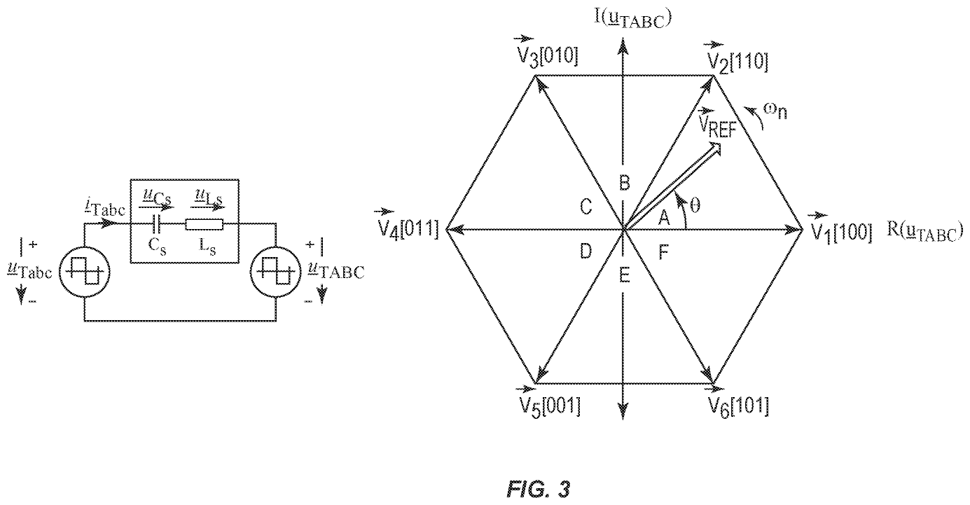

FIG. 2 represents the 3-phase voltage system as transferred into a stationary reference frame (alpha-beta), where the AC input voltage vector U_{abc} is moving with a constant speed given by the grid frequency fn on a circle with a constant amplitude given by the amplitude of the grid voltage. The lefthand side of FIG. 3 illustrates the primary-side and secondary-side line-to-line voltages u_{LLp}, U_{LLs}, respectively, of the transformer device 102 with the resonant tanks generically represented as a single tank Cₛ/Lₛ. The righthand side of FIG. 3 illustrates an SVM (space vector modulation) control scheme for the switch devices S_{N}, S′_{N} of the secondary-side power circuit 110.

A controller 114_2 for the secondary side receives measurement inputs (not shown) such as current measurements, voltage measurements, etc. and generates PWM (pulse width modulation) signals SVM_PWM_S_{N}/S′_{N} for controlling the switch devices S_{N}, S′_{N} of the secondary-side power circuit 110 by SVM. The rectification legs 116 of the secondary-side power circuit 110 may be actively switched half or full bridge rectification legs, and the secondary-side controller 114_2 controls the actively switched half or full bridge rectification legs 116 of the power circuit 110 by SVM such that resonant or quasi-resonant currents flow in the primary side windings 106 and the secondary side windings 108 of the transformer device 102.

SVM defines a plurality of switching and zero voltage vectors. For example, in 7-segment SVM, the switching voltage vectors \vec{V₁} through V₆ correspond to SVM switching states [100], [110], [010], [011], and [101], respectively, as shown in FIG. 3. The zero voltage vectors correspond to SVM switching states and [111].

Each switching voltage vector \vec{V₁} through \vec{V₆} defines a state in which the generated voltage vector of the secondary-side power circuit 110 has non-zero magnitude and phase. The reference vector approximation in SVM shown in the space vector diagram of FIG. 3 includes a regular hexagon with sectors A to F. The voltage space vector \vec{V_{ref}}, which is located in sector A in FIG. 3 as an example, has magnitude of |V_{ref}| and angle of θ and revolves at the grid angular frequency ωₙ. In FIGS. 2 and 3, ‘R’ represents the real axis and ‘I’ the imaginary axis.

The secondary-side controller 114_2 tracks a power reference using SVM-based closed-loop PWM control. The closed-loop control implemented by the secondary-side controller 114_2 is very similar for different SVM-based PWM patterns, such as 7-segment SVM-based PWM, 5-segment SVM-based PWM, 3-segment SVM-based PWM, phase shift PWM based on 7, 5, 3-segment SVM PWM, and any other SVM-based PWM patterns.

The primary-side controller 114_1 operates the multi-phase resonant power converter by switching the bridge converter legs 104 on the primary side within 50% of the resonant frequency, e.g., within 20% or less of the resonant frequency. The resonant frequency is determined by the choice of resonant capacitors Cₛₐ, C_{sb}, C_{sc} and the leakage inductance of the transformer device 102. Input capacitors Cₐ, C_{b}, C_{c} on the primary side are dimensioned/sized to keep the respective bridge-leg input voltages stable at the chosen switching frequency. The input capacitors Cₐ, C_{b}, C_{c} may form part of an EMI filter.

The secondary side of the multi-phase resonant power converter essentially replicates the primary side voltage vector with little variation in length of the voltage space vector, to control the power flow. The voltage vector applied on the secondary side of the transformer device 102 by SVM may be adjustable, such that bidirectional power flow can be realized. For example, the amplitude of the local average can be adjusted within one half switching period of the primary-side converter stage voltage space vector. In another example, a phase shift can be employed on the secondary-side, e.g., in the case of reactive power input from an AC grid.

As shown in FIG. 2, the primary-side switch devices Sₙ, S′ₙ essentially switch at a constant frequency between a voltage space vector in phase with the voltage space vector of the AC input voltage U_{abc} and a voltage space vector that is shifted 180° from the voltage space vector of the AC input voltage U_{abc}, which is applied to the primary side of the resonant tanks 112. The secondary-side switch devices S_{N}, S′_{N} utilize the vectors of SVM shown in the righthand part of FIG. 3 to apply a voltage on the secondary side of the transformer device 102 and drive a certain amount of power through the resonant tanks 112 in the positive and negative primary-side half-switching periods. The PWM signals PWM_Sₙ/S′ₙ generated by the primary-side controller 114_1 for operating the primary-side switch devices Sₙ, S′ₙ are synchronized, such that the primary-side switch devices Sₙ, S′ₙ switch at the same time.

The secondary-side controller 114_2 generates corresponding SVM-based PWM signals SVM_PWM_S_{N}/S′_{N} for controlling the secondary-side power circuit 110 by SVM to apply a voltage on the secondary side, such that power is driven through one or more of the resonant tanks 112 on the primary side in each positive and negative primary-side half-switching period of the primary-side power stage 100. The secondary-side controller 114_2 may adjust the voltage vector applied on the secondary side by the space-vector modulation, to control power flow on the secondary side, e.g., the output voltage U_{dc} in boost mode. The secondary-side controller 114_2 may vary the length of the secondary side voltage vector to control the power flow and provide bi-directional power flow capabilities. Unless pulse skipping is applied in buck mode operation, the primary-side controller 114_1 can simply apply a defined pulse pattern to the switch devices Sₙ, S′ₙ of the power stage 100 whereas the secondary-side controller 114 tracks a power reference with closed-loop SVM control.

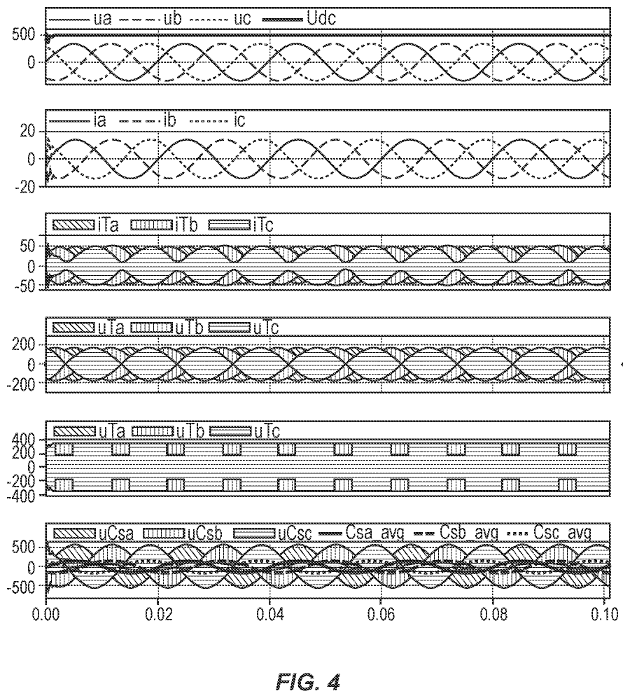

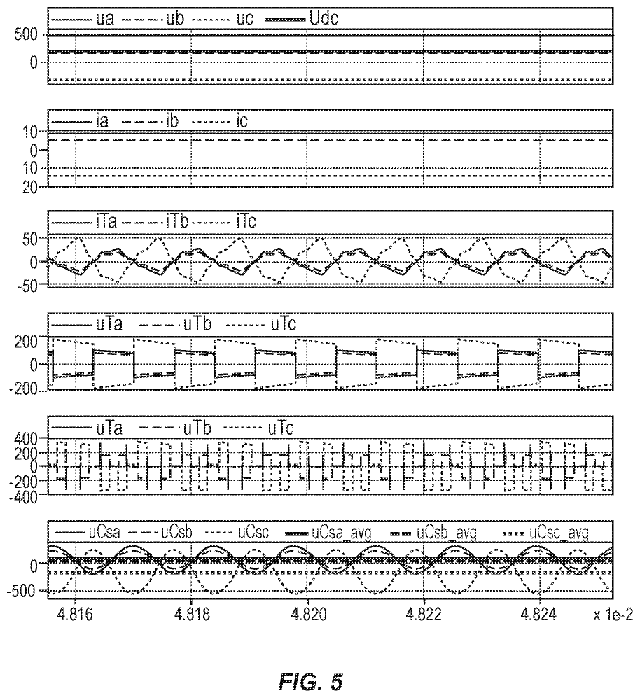

FIG. 4 illustrates simulation results for the multi-phase resonant power converter operated in boost mode, over a mains cycle and for a target output voltage U_{dc} of 500V. The waveforms illustrated in FIG. 4 include the phase (grid) voltages uₐ, u_{b}, u_{c}, the converter output voltage U_{dc}, the phase (grid) currents iₐ, i_{b}, i_{c}, the primary-side transformer currents iTₐ, iT_{b}, IT_{c}, the primary-side transformer winding voltages uTₐ, uT_{b}, uT_{c}, the secondary-side transformer winding voltages uT_{A}, UT_{B}, uT_{C}, the resonant capacitor voltages uCₛₐ, uC_{sb}, uC_{sc} and corresponding periodic averages uC_{sa_avg}, uC_{sb_avg}, uC_{sc_avg}. FIG. 5 illustrates the same simulation results as shown in FIG. 4, but only for part of the mains cycle.

The primary-side controller 114_1 operates the primary-side power stage 100 in boost mode by applying the PWM signals PWM_Sₙ/S′ₙ to the bridge converter legs 104 of the power stage 100 without pulse skipping, such that no resonant power transfer periods are skipped and the secondary-side power circuit 110 outputs a DC voltage U_{dc} that is larger than the line-to-line voltage U_{LLs} of the transformer device 102 on the secondary side. As shown in FIGS. 4 and 5, the converter output voltage U_{dc} is controlled to a constant value while the grid currents iₐ, i_{b}, i_{c} are in phase with the grid voltages uₐ, u_{b}, u_{c}, thus providing PFC functionality.

Also, the primary-side transformer currents iTₐ, IT_{b}, IT_{c} change in magnitude according to the power taken from each grid phase. This means that the current stress in the transformer device 102 and in the primary-side switch devices Sₙ, S′ₙ varies over the grid period, instead of the transformer device 102 and the primary-side switch devices Sₙ, S′ₙ always being stressed with the maximum current drawn from any of the three phases.

An example of boost operation with a 500V output voltage U_{dc} is shown in FIGS. 4 and 5, where no primary-side pulses are skipped. As shown in FIGS. 4 and 5, the SVM-based PWM closed-loop control implemented on the secondary side yields resonant or quasi-resonant currents iTa, iTb, iTc in the primary side windings 106 of the transformer device 102 which appear as resonant or quasi-resonant currents in the secondary side windings 108.

As shown in FIGS. 4 and 5, the primary-side power stage 100 reduces the grid voltage level by half such that the transformer primary-side voltages toggle between +/−0.5*U_{abc}. The transformer device 102 may have a non-unity winding ratio. In this case, the voltage U_{LLs} resulting on the secondary-side transformer windings 108 is relevant for the minimum dc-link voltage in boost operation without pulse skipping, where the minimum dc-link voltage for boost operation is defined by the line-to-line voltage of the transformer secondary-side windings 108.

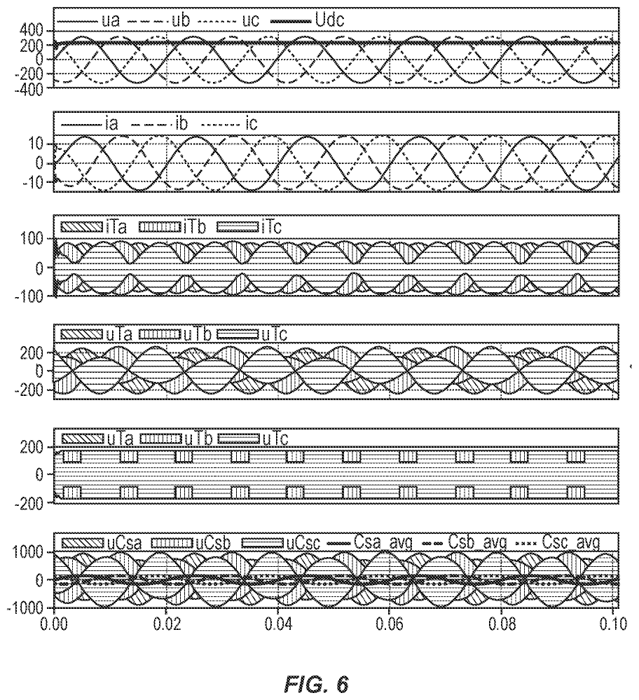

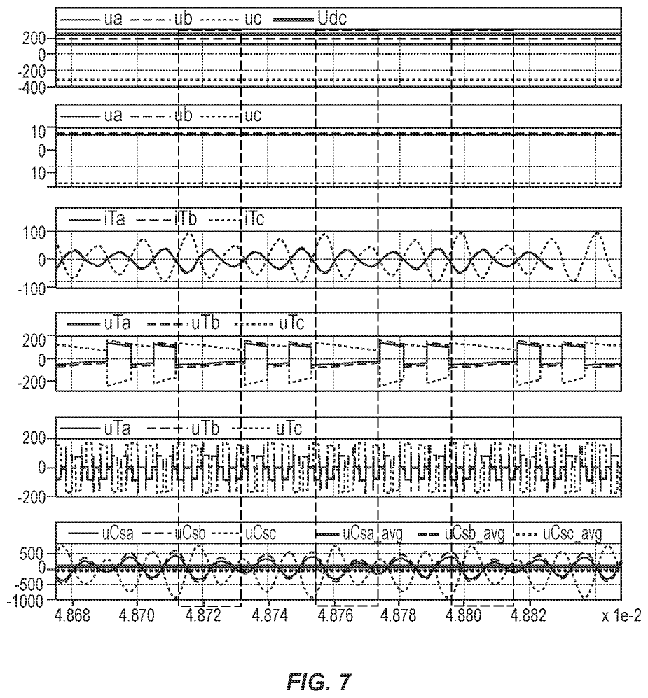

FIG. 6 illustrates the same waveforms as FIG. 4, but for a simulation of the multi-phase resonant power converter in buck mode and for a target output voltage U_{dc} of 200V. FIG. 7 illustrates the same simulation results as shown in FIG. 6, but only for part of the mains cycle.

With the previously described boost control scheme, to apply a proper voltage vector on the secondary side, the output voltage U_{dc} has to be higher than the voltage uT_{A}, UT_{B}, UT_{C} applied on the primary side, assuming a 1:1 transformer ratio. To enable buck (lower voltage) operation, the primary-side controller 114_1 operates the primary-side power stage 100 by applying PWM signals PWM_Sₙ/S′ₙ to the bridge converter legs 104 of the power stage 100 with pulse skipping, such that an integer number of resonant power transfer periods are periodically skipped and the secondary-side power circuit 100 outputs a DC voltage U_{dc} that is lower than the line-to-line voltage u_{LLs} of the transformer device 102 on the secondary side. By skipping an integer number (1, 2, 3, etc.) of primary side resonant periods, the primary side voltage vector amplitude at the transformer terminals is, on average, reduced in length. This allows to lower the output voltage U_{dc} and at the same time to control the power flow with SVM on the secondary side, as is the case for boost operation. An example of buck operation with a 250V output voltage U_{dc} is shown in FIGS. 6 and 7, where one (1) out of every three (3) primary-side pulses is skipped as indicated by the vertical dashed rectangles in FIG. 7.

The AC input voltage U_{abc} applied to the power stage 100 on the primary side of the multi-phase resonant power converter may be a single-phase voltage or a multi-phase voltage. In FIG. 1, the AC input voltage U_{abc} has three (3) phases uₐ, u_{b}, u_{c}. Also in FIG. 1, each bridge converter leg 104 of the primary-side power stage 100 receives a separate phase un of the AC input voltage U_{abc} and includes a single pair of bidirectional switch devices Sₐ, S′ₐ electrically connected in a half bridge configuration. The primary-side controller 114_1 operates the bridge converter legs 104 of the power stage 100 in synchronization under PWM control with 50% duty cycle.

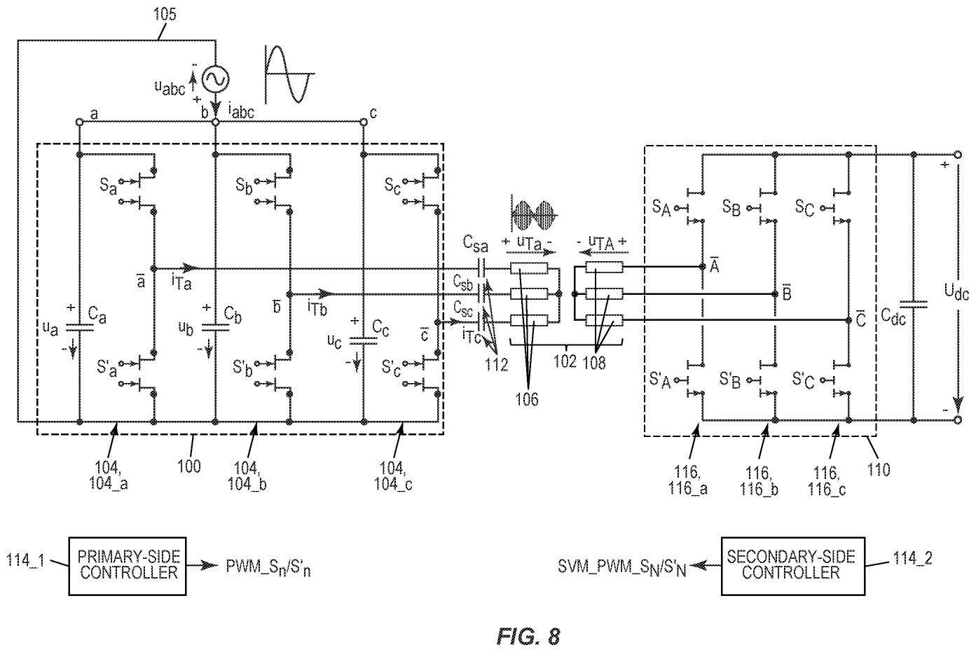

FIG. 8 illustrates an embodiment of the multi-phase resonant power converter where the AC input voltage U_{abc} has a single phase. According to this embodiment, the bridge converter legs 104 of the primary-side power stage 100 are in parallel with one another and receive the same single-phase of the AC input voltage U_{abc}. The multi-phase resonant power converter has P phases where P is a positive integer greater than or equal to 1, and the multi-phase resonant power converter can operate on a single-phase grid by connecting all phase terminals a, b, c, etc. of the primary-side power stage 100 in parallel to the single-phase grid. Each bridge converter leg 104 of the primary-side power stage 100 may have a single pair of bidirectional switch devices Sₙ, S′ₙ electrically connected in a half bridge configuration, e.g., as shown in FIG. 8, or two pairs of bidirectional switch devices electrically connected in a full bridge configuration. The primary-side controller 114_1 operates the bridge converter legs 104 of the primary-side power stage 100 with a 360°/P phase shift under PWM control with 50% duty cycle, according to this embodiment.

The phase shift employed in the single-phase operation ensures adequate power transfer. In single-phase operation, all primary-side bridge converter legs 104 are connected to the same grid voltage U_{abc}. Synchronous PWM with 50% on-time in this case would only generate common mode switch-node voltages and no power would be transferred to the secondary side; Hence, the use of 360°/P-phase shift for single-phase operation.

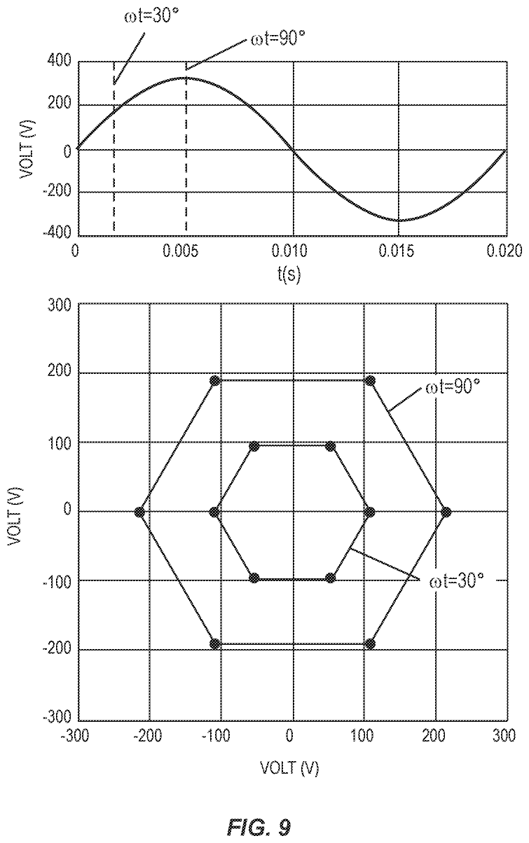

In the example of FIG. 8, P=3 and the phase shift is 120° while still operating at 50% duty cycle. As illustrated in the lower part of FIG. 9, such a control scheme creates a hexagon pattern of voltage vectors in the alpha-beta plane, where the diameter of the pattern scales with the angle ωt of the AC input voltage U_{abc}, i.e., grows and shrinks with twice the grid frequency. The upper part of FIG. 9 shows the single phase of the AC input voltage U_{abc} over time. The secondary-side controller 114 applies pulses on the secondary side with varying duty cycles, where the length of the pulses depends on the phase angle ωt and the desired power flow.

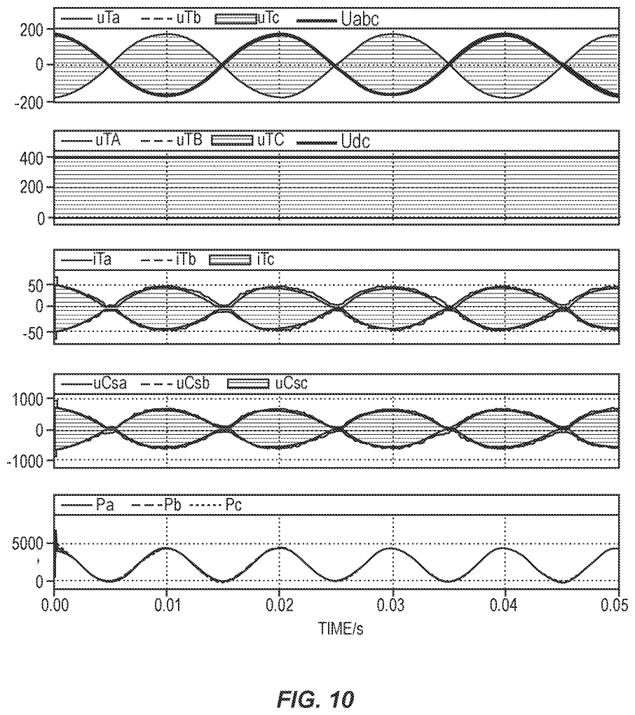

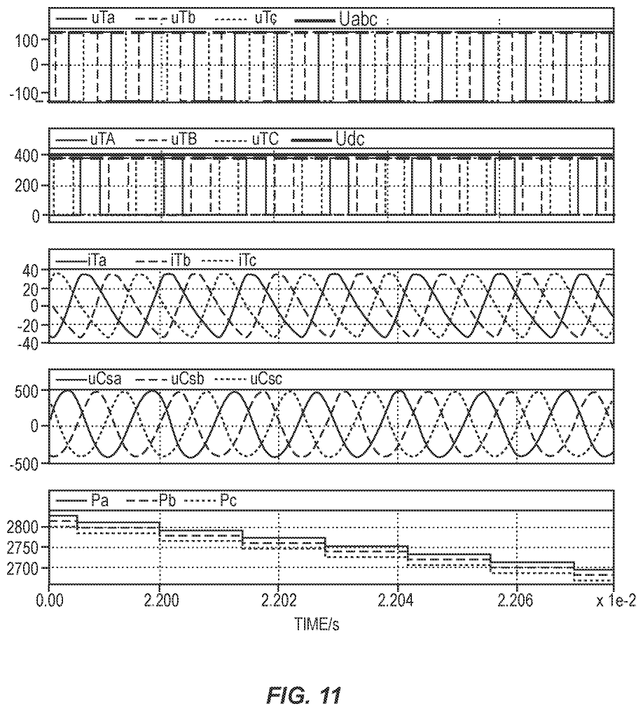

FIG. 10 illustrates simulation results for the multi-phase resonant power converter embodiment of FIG. 8, over a mains cycle and for a target output voltage U_{dc} of 400V. The waveforms illustrated in FIG. 10 include the primary-side transformer winding voltages uTₐ, uT_{b}, uT_{c}, the single-phase AC input voltage U_{abc}, the secondary-side transformer winding voltages uT_{A}, uT_{B}, uT_{c}, the converter output voltage U_{dc}, the primary-side transformer currents iTₐ, iT_{b}, iT_{c}, the resonant capacitor voltages uCₛₐ, uC_{sb}, uC_{sc}, and the power flow Pa, Pb, Pc for each phase of the multi-phase resonant power converter. FIG. 11 illustrates the same simulation results as shown in FIG. 10, but only for part of the mains cycle.

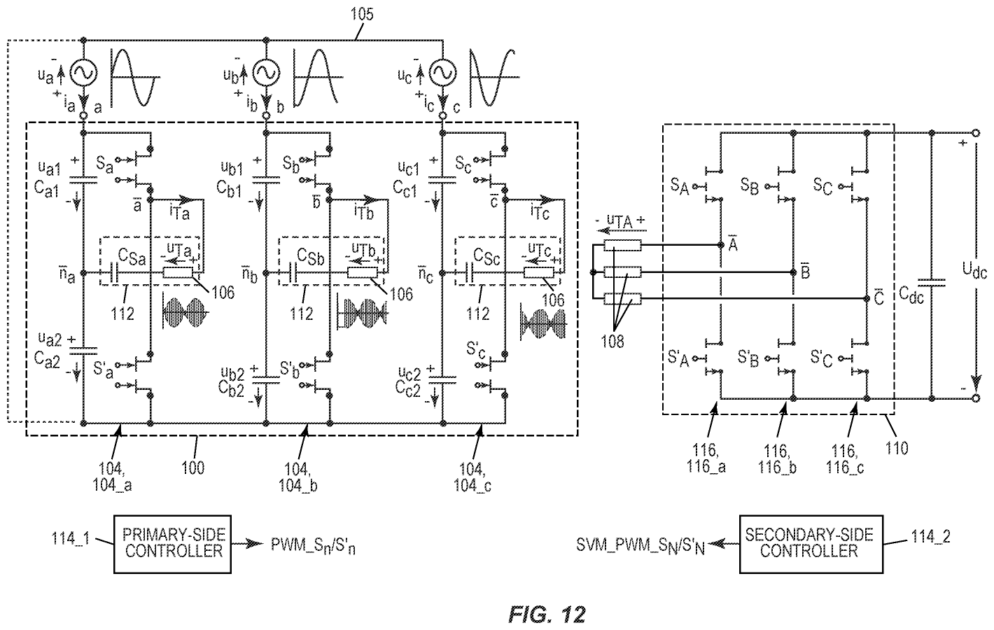

FIG. 12 illustrates the multi-phase resonant power converter, according to another embodiment. In FIG. 12, the capacitive leg in parallel with each actively controlled leg Sₙ/S′ₙ, of the primary-side power stage 100 includes an upper capacitor Cₙ₁ in series with a lower capacitor Cₙ₂ at a midpoint n̅ₙ̅ of the capacitive leg. Each resonant tank 112 on the primary side is electrically connected between the capacitive leg midpoint n̅ₙ̅ and the bridge converter leg midpoint n for the corresponding phase of the power stage 100.

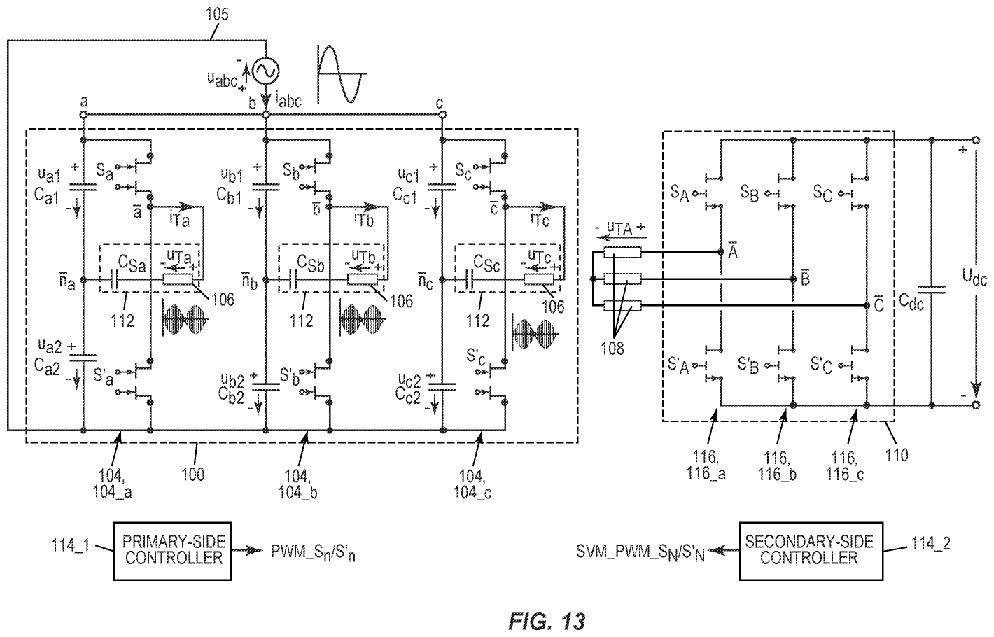

FIG. 13 illustrates the multi-phase resonant power converter, according to another embodiment. In FIG. 13, the AC input voltage U_{abc} has a single phase (as in FIG. 8) and the capacitive leg in parallel with each actively controlled leg Sₙ/S′ₙ, of the primary-side power stage 100 includes an upper capacitor Cₙ₁ in series with a lower capacitor Cₙ₂ at the midpoint n̅ₙ̅ of the capacitive leg (as in FIG. 13). As such, the embodiment illustrated in FIG. 13 combines the features of FIGS. 8 and 12.

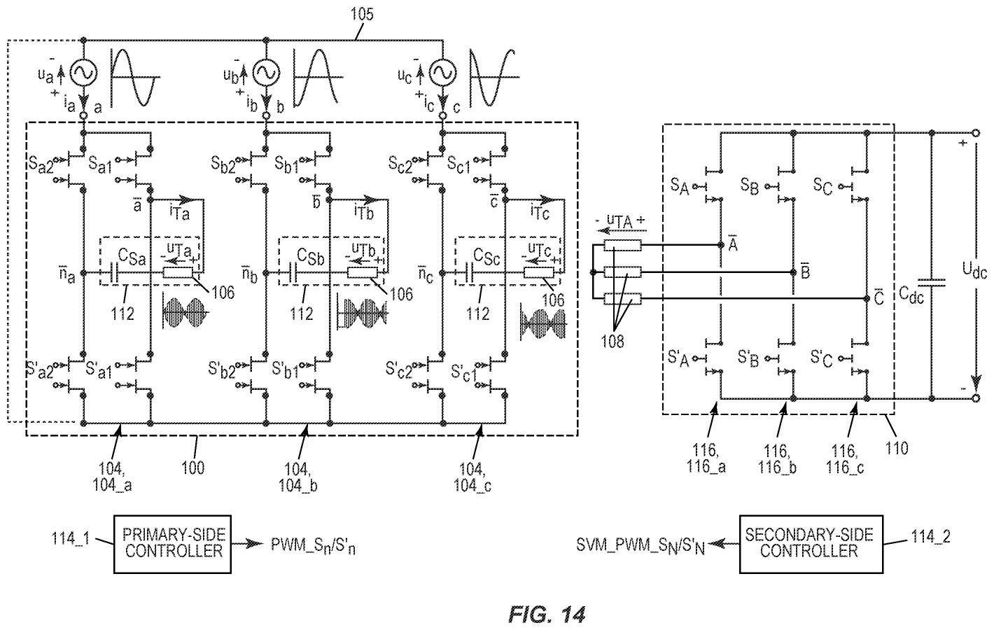

FIG. 14 illustrates the multi-phase resonant power converter, according to another embodiment. In FIG. 14, the dual-capacitor capacitive legs on the primary side are replaced with another active bridge leg. According to this embodiment, each bridge converter leg 104 of the primary-side power stage 100 receives a separate phase un of the AC input voltage U_{abc} and has two pairs of bidirectional switch devices Sₙ₁/S′ₙ₁, Sₙ₂/S′ₙ₂ electrically connected in a full bridge configuration. The primary-side controller 114_1 operates the bridge converter legs 104 of the power stage 100 in synchronization under PWM control with 50% duty cycle in this embodiment. In one embodiment, the power switch devices Sₙ₁/S′ₙ₁, Sₙ₂/S′ₙ₂ each have a voltage rating defined by the corresponding phase-to-neutral voltage of the AC input voltage U_{abc} instead of the line-to-line voltage which can be 600V, for example.

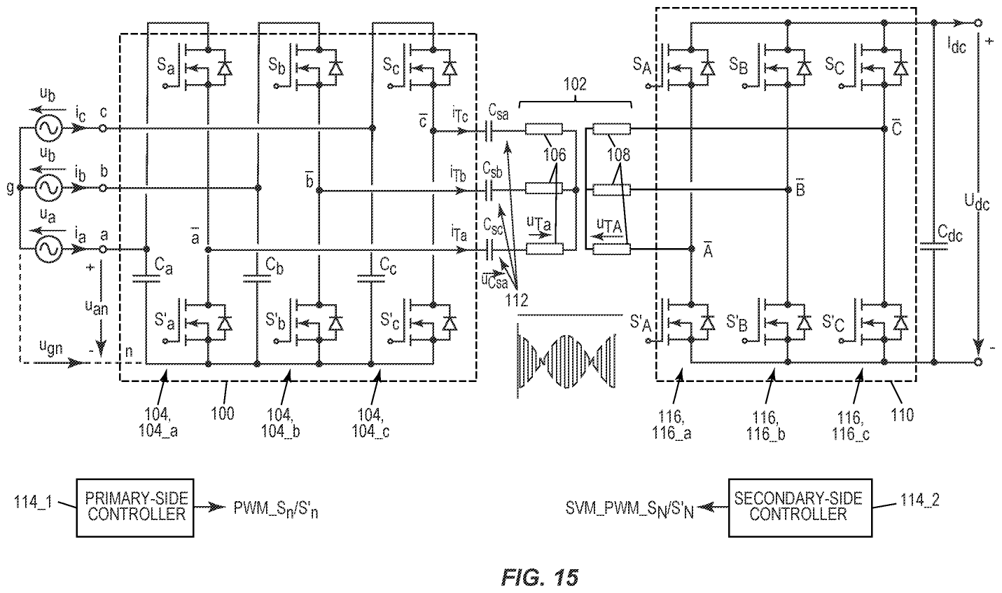

FIG. 15 illustrates the multi-phase resonant power converter, according to another embodiment. In FIG. 15, the single pair of power switch devices Sₙ/S′ₙ that form each bridge converter leg 104 of the primary-side power stage 100 have unidirectional voltage blocking capability. As such, the power switch devices Sₙ/S′ₙ that form each bridge converter leg 104 have a single gate in FIG. 15. According to the embodiment of FIG. 15, the multi-phase resonant power converter has P phases where P is a positive integer greater than or equal to 2, and the primary-side controller 114_1 operates the bridge converter legs 104 of the power stage 100 in synchronization under PWM control with 50% duty cycle. The unidirectional power switch devices Sₙ/S′ₙ in FIG. 15 may be Si or SiC power MOSFETs, unidirectional GaN HEMTs, etc. and have a voltage rating >800V, for example.

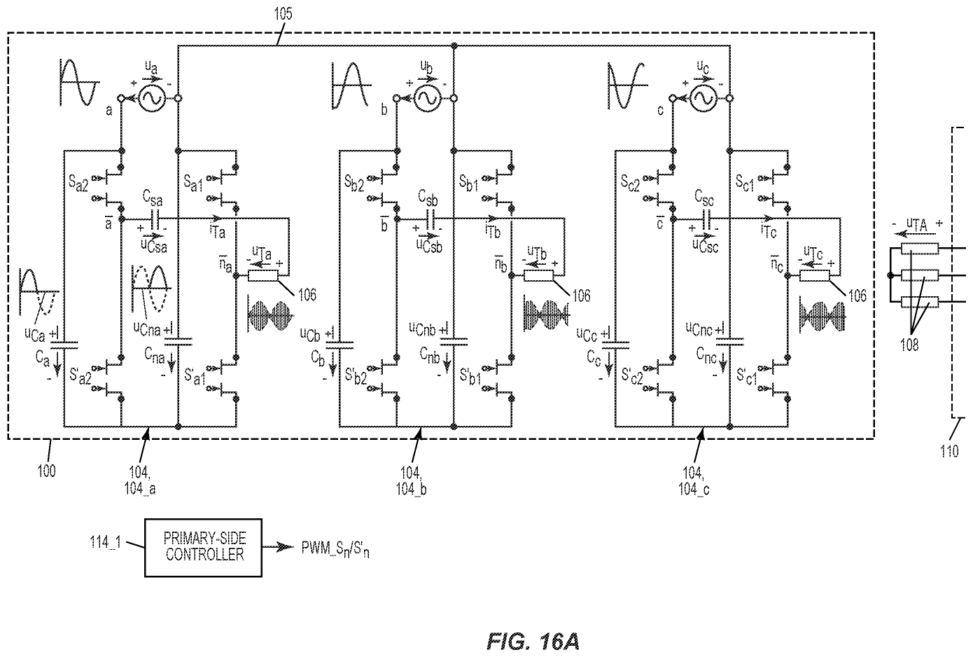

FIG. 16 illustrates the multi-phase resonant power converter, according to another embodiment. In FIG. 16, each bridge converter leg 104 of the primary-side power stage 100 includes two pairs of power switch devices Sₙ₁/S′ₙ₂ having unidirectional voltage blocking capability. Compared to the unidirectional power switch devices Sₙ/S′ₙ in FIG. 15, the unidirectional power switch devices Sₙ₁/S′ₙ₂ in FIG. 16 may have a voltage rating >400V, for example. The unidirectional power switch devices Sₙ₁/S′ₙ₂ in FIG. 16 may be Si or SiC power MOSFETs, unidirectional GaN HEMTs, etc.

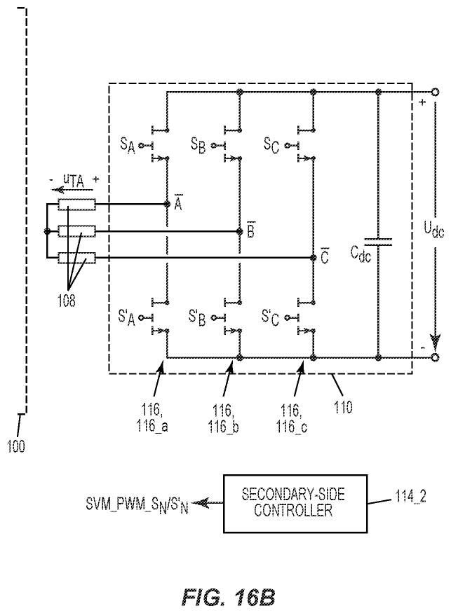

FIG. 17 illustrates a schematic diagram of the power circuit 110 on the secondary side of the multi-phase resonant power converter, according to another embodiment. In FIG. 17, the multi-phase resonant power converter has P phases where P is a positive integer greater than or equal to 2 and the secondary-side power circuit 110 has M half bridge rectification legs 116 where M is a positive integer greater than or equal to P+1. In FIG. 17, the secondary-side bridge rectification legs 116 are shown as half bridge rectification legs 116 each implemented as a single pair of unidirectional power switch devices S_{N}/S′_{N} such as Si or SiC power MOSFETs, unidirectional GaN HEMTs, etc. electrically connected in series at a midpoint N̅ of the actively switched half bridge rectification leg 116.

In either case, the additional secondary-side rectification leg(s) 116_d enable one or more additional degrees of freedom (i.e., more independence among the phases) for the secondary-side controller 114_2 when implementing the SVM-based closed-loop PWM. One additional secondary-side rectification leg 116_d is shown in FIG. 17. More generally, the secondary-side power circuit 110 may have one or more additional secondary-side rectification legs 116_d beyond the number of phases being supported by the multi-phase resonant power converter.

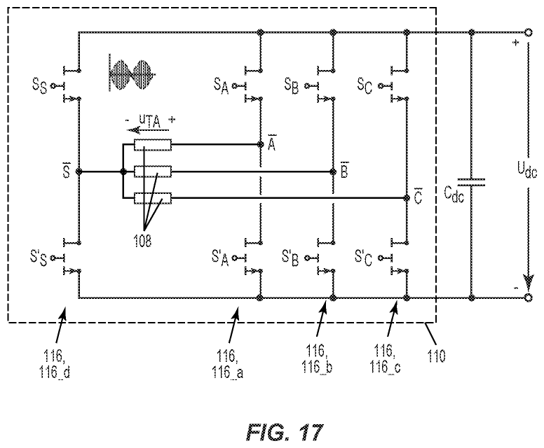

FIG. 18 illustrates a schematic diagram of the power circuit 110 on the secondary side of the multi-phase resonant power converter, according to another embodiment. In FIG. 18, the bridge rectification legs 116 of the secondary-side power circuit 110 are connected to the secondary side windings 108 of the transformer device 102 in a delta-configuration.

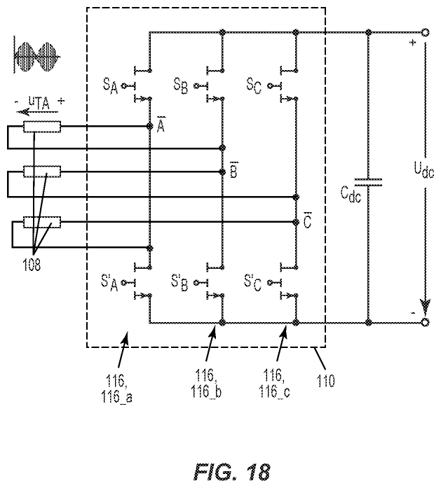

FIG. 19 illustrates a schematic diagram of the power circuit 110 on the secondary side of the multi-phase resonant power converter, according to another embodiment. In FIG. 19, the secondary-side power circuit 110 has at least one additional secondary-side rectification leg 116_d beyond the number of phases being supported by the multi-phase resonant power converter, where four (or more) instead of three winding terminals are accessible and connected to the four (or more) secondary-side rectification legs 116, which enables further degrees of freedom.

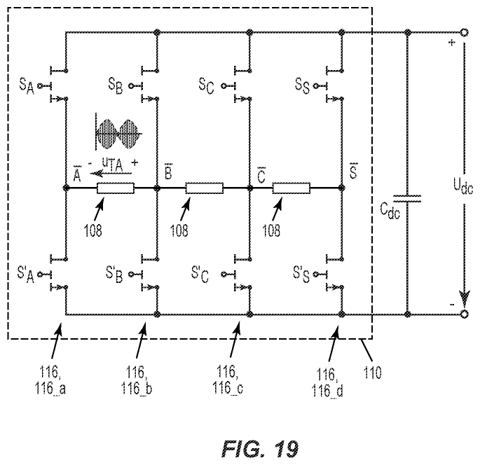

FIG. 20 illustrates a schematic diagram of the power circuit 110 on the secondary side of the multi-phase resonant power converter, according to another embodiment. In FIG. 20, the bridge rectification legs 116 of the secondary-side power circuit 110 are full bridge rectification legs each implemented by a first pair of unidirectional power switch devices S_{N1}/S′_{N1} electrically connected in series at a first midpoint N̅1̅ of the actively switched full bridge rectification leg 116 and a second pair of unidirectional power switch devices S_{N2}/S′_{N2} electrically connected in series at a second midpoint N̅2̅ of the actively switched full bridge rectification leg 116 and in parallel with the first pair of unidirectional power switch devices S_{N1}/S′_{N1}. The full bridge rectification legs 116 are electrically connected in parallel to form a single DC output U_{dc} of the secondary-side power circuit 110. The unidirectional power switch devices S_{N1}/S′_{N1}, S_{N2}/S′_{N2} that form the full bridge rectification legs 116 may be Si or SiC power MOSFETs, unidirectional GaN HEMTs, etc. With the full bridge implementation of the secondary-side power circuit 110, the full bridge rectification legs 116 utilize both +U_{dc} and −U_{dc} which allows to halve the transformer currents iTa, iTb, iTc. Zero intervals can be inserted in case of high dc output voltages. More generally, additional degrees of freedom for SVM are achieved.

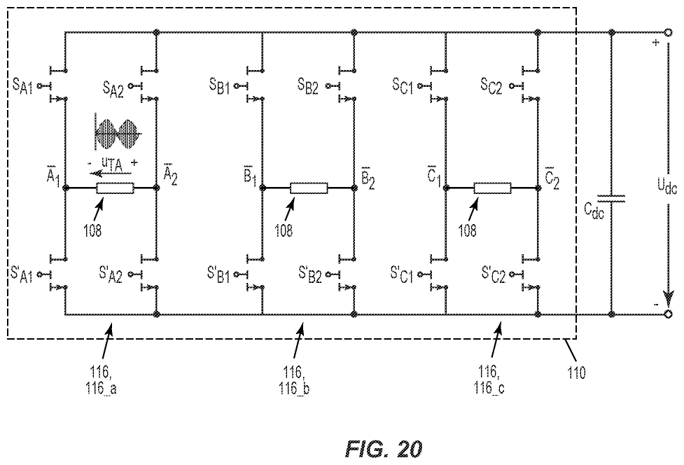

FIG. 21 illustrates a schematic diagram of the power circuit 110 on the secondary side of the multi-phase resonant power converter, according to another embodiment. In FIG. 21, the secondary-side power circuit 110 is a diode rectifier which requires no active control on the secondary side. The diode rectifier has a diode rectification leg 200 for each phase of the multi-phase resonant power converter. Each diode rectification leg 200 on the secondary side includes a pair of diode devices D_{N}, D′_{N} electrically connected in series at the midpoint N̅ of the diode rectification leg 200.

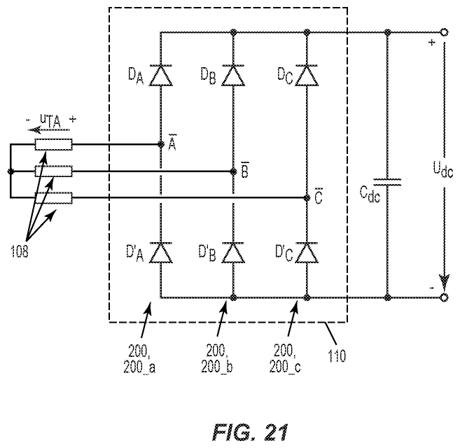

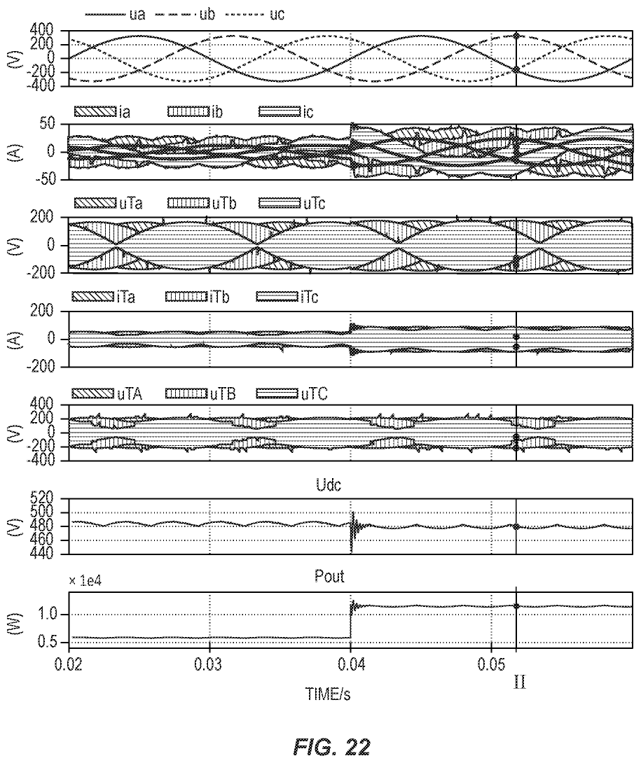

FIG. 22 illustrates simulation results for the diode rectifier power circuit embodiment of FIG. 21, over a mains cycle and for a target output voltage U_{dc} of about 480V. The waveforms illustrated in FIG. 22 include the phase (grid) voltages uₐ, u_{b}, u_{c}, the phase (grid) currents iₐ, i_{b}, i_{c}, the primary-side transformer winding voltages uTₐ, uT_{B}, uT_{C}, the primary-side transformer currents iTₐ, iT_{b}, iT_{c}, the secondary-side transformer winding voltages uT_{A}, UT_{B}, uT_{C}, the converter output voltage U_{dc}, the converter power output Pₒᵤₜ. FIG. 23 illustrates the same simulation results as shown in FIG. 22, but only for part of the mains cycle.

According to this embodiment, the multi-phase resonant power converter has P phases where P is a positive integer greater than or equal to 2. The primary-side controller 114_1 operates the bridge converter legs 104 of the primary-side power stage 100 with a 360°/P phase shift under PWM control with 50% duty cycle, such that resonant or quasi-resonant currents flow in the primary side windings 106 and the secondary side windings 108 of the transformer device 102. No active control is directly performed on the secondary side in this embodiment. The primary-side controller 114_1 may operate the bridge converter legs 104 of the primary-side power stage 100 with pulse skipping to control the DC output voltage U_{dc} of the secondary-side power circuit 110.

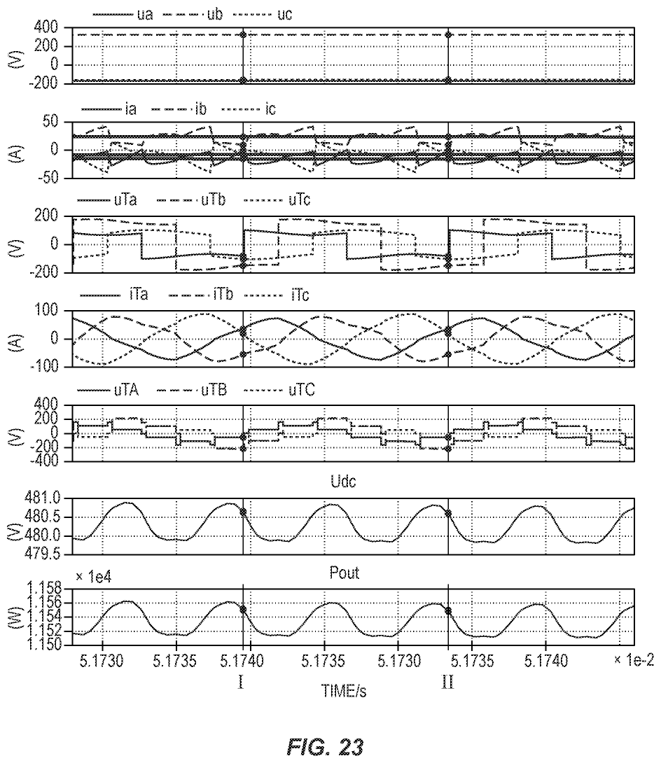

FIG. 24 illustrates the multi-phase resonant power converter, according to another embodiment. In FIG. 24, the resonant tanks 112 are on the secondary side of the power converter instead of the primary side. According to this embodiment, each separate resonant tank 112 is electrically connected to the midpoint N̅ of a corresponding secondary-side bridge converter leg 116. Each resonant tank 112 on the secondary side of the power converter includes a resonant capacitor Cₛₙ in series with the secondary side winding 108 for that secondary-side bridge converter leg 116. The resonant frequency of each resonant tank 112 is tuned to within +/−50% of the switching frequency used by the primary-side controller 114_1, as previously described herein. The primary-side power stage 100 may have any of the configurations previously described herein in connection with FIG. 1, FIG. 8, and FIGS. 12 through 16.

The multi-phase resonant power converter may also include a separate low-frequency AC blocking capacitor Con electrically connected to the midpoint n of each primary-side bridge converter leg 104 and in series with the primary side winding 106 for that primary-side bridge converter leg 104. The low-frequency AC blocking capacitors C_{ba}, C_{bb}, C_{bc} are not tuned to the resonant frequency of the resonant tanks 112 on the secondary side. Instead, the AC blocking capacitors C_{ba}, C_{bb}, C_{bc} are selected/sized to provide low frequency AC blocking and therefore prevent saturation of the transformer device 102.

The AC blocking capacitors C_{ba}, C_{bb}, C_{bc} present a high enough impedance at the grid frequency so that little or no low frequency voltage components appear across the transformer device 102, but are large enough such that the AC blocking capacitors C_{ba}, C_{bb}, C_{bc} are electrically invisible at the switching frequency compared to the transformer leakage inductance. Accordingly, selection/sizing of the AC blocking capacitors C_{ba}, C_{bb}, C_{bc} is quite different from that of the resonant capacitors Cₛₐ, C_{sb}, C_{sc} on the secondary side and the resonant capacitors Cₛₐ, C_{sb}, C_{sc} are likely to be at least one order of magnitude different than the AC blocking capacitors C_{ba}, C_{bb}, C_{bc}.

The transformer device 102 included in the multi-phase resonant power converter may be implemented as a separate transformer for each phase supported by the multi-phase resonant power converter. According to this embodiment, each separate transformer includes a discrete magnetic core and the primary winding 106 and the secondary winding 108 for that phase wound on the core.

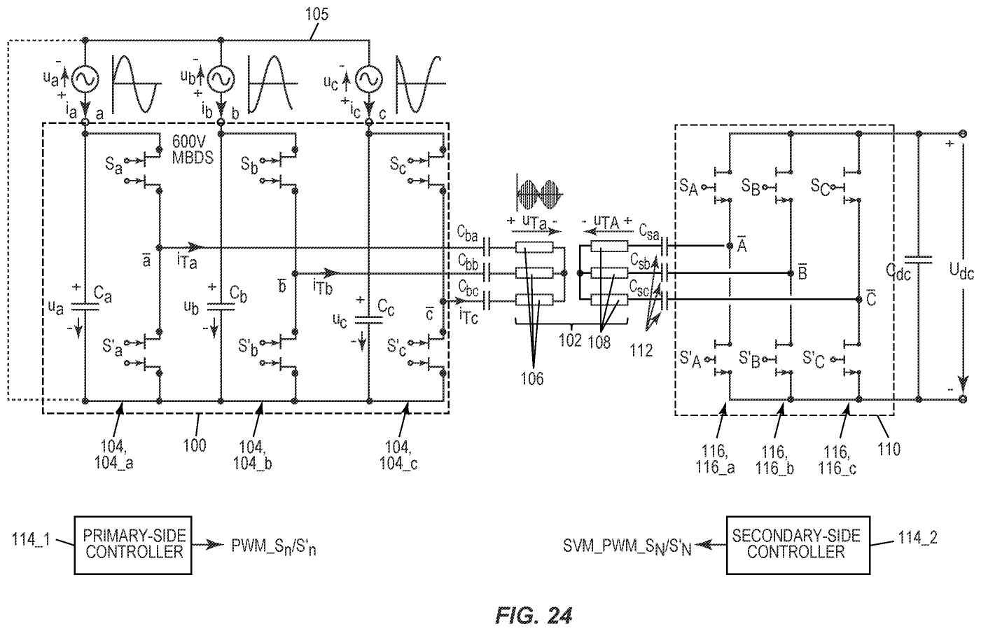

FIG. 25 illustrates a schematic diagram of the transformer device 102, according to another embodiment. In FIG. 25, the primary side windings 106 and the secondary side windings 108 of the transformer device 102 are integrated with a single magnetic structure 300. The magnetic structure has a magnetic leg 302 for each phase n of the power converter. For each phase of the power converter, the primary winding 106 and the secondary winding 108 of the transformer device 102 is wound on the same magnetic leg 302. With this approach, lower rated power switch devices (e.g., 650V) can be used in a half bridge configuration for lower component count while also integrating the primary and secondary side windings 106, 108 into a single transformer structure. Such an approach yields offers a multi-phase resonant power converter solution that has reduced cost and smaller footprint.

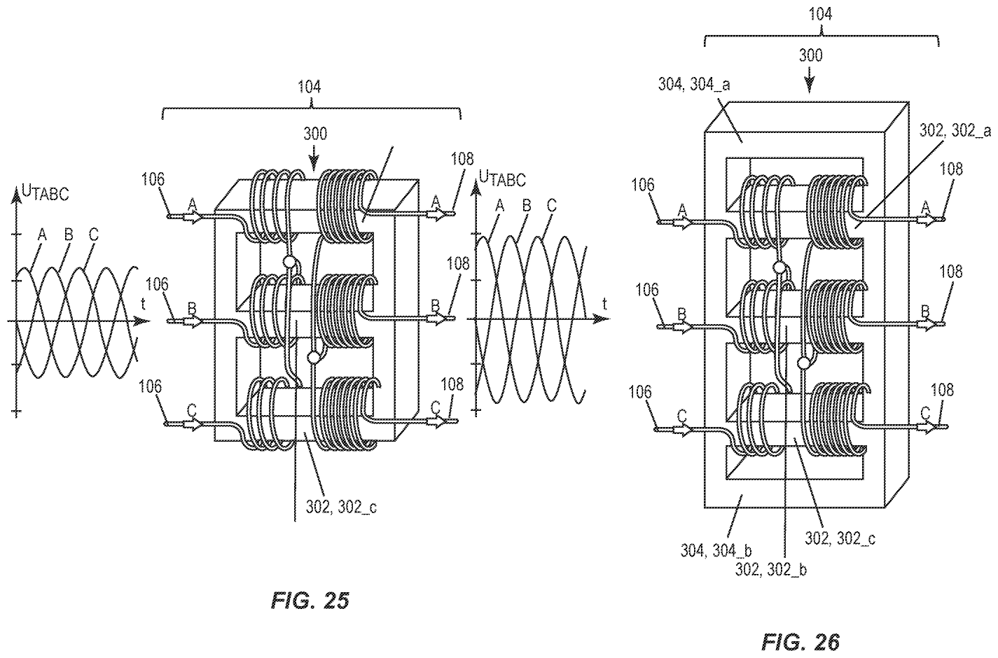

FIG. 26 illustrates the transformer device 102, according to another embodiment. The embodiment shown in FIG. 26 is similar to the embodiment shown in FIG. 25. In FIG. 26, however, the single magnetic structure 300 has at least one additional magnetic leg 304 for adjusting leakage flux of the transformer device 102 and thus the resonant frequency of the resonant tanks 112. No windings are wound on the additional magnetic leg(s) 304. Two (2) additional magnetic legs 304_a, 304_b are shown in FIG. 26. More generally, the single magnetic structure 300 may have one or more additional magnetic legs 304.

Although the present disclosure is not so limited, the following numbered examples demonstrate one or more aspects of the disclosure.

Example 1. A multi-phase resonant power converter, comprising: a power stage on a primary side of the multi-phase resonant power converter, the power stage comprising a plurality of bridge converter legs each configured to receive an AC input voltage and implement a separate phase of the multi-phase resonant power converter; a transformer device having a primary side winding for each bridge converter leg of the power stage, and a secondary side winding for each primary side winding; a power circuit electrically connected to the secondary side windings of the transformer device on a secondary side of the multi-phase resonant power converter; a primary-side controller configured to operate the bridge converter legs of the power stage at a switching frequency; and a separate resonant tank electrically connected to a midpoint of each bridge converter leg of the power stage, each resonant tank comprising a resonant capacitor in series with the primary side winding for that bridge converter leg, wherein a resonant frequency of each resonant tank is tuned to within +/−50% of the switching frequency.

Example 2. The multi-phase resonant power converter of example 1, wherein each bridge converter leg of the power stage comprises a plurality of switch devices, and wherein the primary-side controller is configured to operate the switch devices at a constant switching frequency between a voltage space vector in phase with a voltage space vector of the AC input voltage and a voltage space vector that is shifted 180° from the voltage space vector of the AC input voltage.

Example 3. The multi-phase resonant power converter of example 2, wherein a secondary-side controller is configured to control the power circuit by space-vector modulation to apply a voltage on the secondary side, such that power is driven through one or more of the resonant tanks on the primary side in each positive and negative primary-side half-switching period of the power stage.

Example 4. The multi-phase resonant power converter of example 3, wherein the secondary-side controller is configured to adjust a voltage vector applied on the secondary side by the space-vector modulation, to control power flow on the secondary side.

Example 5. The multi-phase resonant power converter of any of examples 1 through 4, wherein the AC input voltage has a plurality of phases, wherein each bridge converter leg of the power stage is configured to receive a separate phase of the AC input voltage and comprises a single pair of bidirectional switch devices electrically connected in a half bridge configuration, and wherein the primary-side controller is configured to operate the bridge converter legs of the power stage in synchronization under PWM (pulse width modulation) control with 50% duty cycle.

Example 6. The multi-phase resonant power converter of any of examples 1 through 4, wherein the AC input voltage has a plurality of phases, wherein each bridge converter leg of the power stage is configured to receive a separate phase of the AC input voltage and comprises two pairs of bidirectional switch devices electrically connected in a full bridge configuration, and wherein the primary-side controller is configured to operate the bridge converter legs of the power stage in synchronization under PWM (pulse width modulation) control with 50% duty cycle.

Example 7. The multi-phase resonant power converter of any of examples 1 through 4, wherein the AC input voltage has a plurality of phases, wherein each bridge converter leg of the power stage is configured to receive a separate phase of the AC input voltage and comprises a single pair of power switch devices having unidirectional voltage blocking capability and electrically connected in a half bridge configuration or two pairs of power switch devices having unidirectional voltage blocking capability and electrically connected in a full bridge configuration, wherein the multi-phase resonant power converter has P phases and P is a positive integer greater than or equal to 2, and wherein the primary-side controller is configured to operate the bridge converter legs of the power stage in synchronization under PWM (pulse width modulation) control with 50% duty cycle.

Example 8. The multi-phase resonant power converter of any of examples 1 through 4, wherein the AC input voltage has a single phase, wherein the bridge converter legs of the power stage are in parallel with one another and configured to receive the single-phase of the AC input voltage, wherein the multi-phase resonant power converter has P phases and P is a positive integer greater than or equal to 1, and wherein the primary-side controller is configured to operate the bridge converter legs of the power stage with a 360°/P-phase shift under PWM (pulse width modulation) control with 50% duty cycle.

Example 9. The multi-phase resonant power converter of example 8, wherein each bridge converter leg of the power stage comprises a single pair of bidirectional switch devices electrically connected in a half bridge configuration or two pairs of bidirectional switch devices electrically connected in a full bridge configuration.

Example 10. The multi-phase resonant power converter of any of examples 1 through 5 and 7 through 9, wherein each bridge converter leg of the power stage is a half bridge converter leg comprising: an actively controlled leg formed by two power switch devices electrically connected in series at the midpoint of the bridge converter leg; and a capacitive leg in parallel with the actively controlled leg.

Example 11. The multi-phase resonant power converter of any of examples 1 through 10, wherein the primary-side controller is configured to operate the power stage in a boost mode by applying PWM (pulse width modulation) signals to the bridge converter legs of the power stage without pulse skipping, such that no resonant power transfer periods are skipped and the power circuit outputs a DC voltage that is larger than a line-to-line voltage of the transformer device on the secondary side.

Example 12. The multi-phase resonant power converter of any of examples 1 through 11, wherein the primary-side controller is configured to operate the power stage in a buck mode by applying PWM (pulse width modulation) signals to the bridge converter legs of the power stage with pulse skipping, such that an integer number of resonant power transfer periods are periodically skipped and the power circuit outputs a DC voltage that is lower than a line-to-line voltage of the transformer device on the secondary side.

Example 13. The multi-phase resonant power converter of any of examples 1 through 12, wherein the power circuit comprises an actively switched half or full bridge rectification leg for each phase of the multi-phase resonant power converter, and wherein a secondary-side controller is configured to control the actively switched half or full bridge rectification legs of the power circuit by space-vector modulation such that quasi-resonant currents flow in the primary side windings and the secondary side windings of the transformer device.

Example 14. The multi-phase resonant power converter of any of examples 1 through 12, wherein the power circuit is a diode rectifier, wherein the multi-phase resonant power converter has P phases and P is a positive integer greater than or equal to 2, and wherein the primary-side controller is configured to operate the bridge converter legs of the power stage with a op-phase shift under PWM (pulse width modulation) control with 50% duty cycle.

Example 15. The multi-phase resonant power converter of any of examples 1 through 12 and 14, wherein the power circuit is a diode rectifier, and wherein the primary-side controller is configured to operate the bridge converter legs of the power stage with pulse skipping to control a DC output of the power circuit.

Example 16. The multi-phase resonant power converter of any of examples 1 through 15, wherein the multi-phase resonant power converter has P phases and P is a positive integer greater than or equal to 2, and wherein the power circuit comprises M half or full bridge rectification legs and M is a positive integer greater than or equal to P+1.

Example 17. The multi-phase resonant power converter of any of examples 1 through 16, wherein each bridge converter leg of the power stage comprises a single pair of switch devices electrically connected in a half bridge configuration or two pairs of switch devices electrically connected in a full bridge configuration, and wherein for each bridge converter leg of the power stage, a voltage rating of each switch device included in the bridge converter leg of the power stage is defined by a phase-to-neutral voltage of the AC input voltage.

Example 18. The multi-phase resonant power converter of any of examples 1 through 17, wherein the primary side windings and the secondary side windings of the transformer device are integrated with a single magnetic structure.

Example 19. The multi-phase resonant power converter of example 18, wherein the single magnetic structure has a magnetic leg for each phase of the power converter, and wherein for each phase of the power converter, the primary winding and the secondary winding of the transformer device is wound on the same magnetic leg.

Example 20. The multi-phase resonant power converter of example 18 or 19, wherein the single magnetic structure has at least one additional magnetic leg for adjusting leakage flux of the transformer device and thus the resonant frequency of the resonant tanks.

Example 21. The multi-phase resonant power converter of any of examples 1 through 20, wherein the power circuit comprises a separate half or full bridge rectification leg for each phase of the power stage, wherein the bridge converter legs of the power stage are connected to the primary side windings of the transformer device in a Y-configuration or a delta-configuration, and wherein the half or full bridge rectification legs of the power circuit are connected to the secondary side windings of the transformer device in a Y-configuration or a delta-configuration.

Example 22. The multi-phase resonant power converter of any of examples 1 through 21, wherein the power circuit comprises a separate half or full bridge rectification leg for each phase of the power stage, wherein the half or full bridge rectification legs are electrically connected in parallel to form a single DC output of the power circuit, and wherein the primary side windings and the secondary side windings of the transformer device are integrated with a single magnetic structure.

Example 23. A method of operating a multi-phase resonant power converter that includes a power stage on a primary side of the multi-phase resonant power converter, the power stage comprising a plurality of bridge converter legs each configured to implement a separate phase of the multi-phase resonant power converter, a transformer device having a primary side winding for each bridge converter leg of the power stage and a secondary side winding for each primary side winding, a power circuit electrically connected to the secondary side windings of the transformer device on a secondary side of the multi-phase resonant power converter, and a separate resonant tank electrically connected to a midpoint of each bridge converter leg of the power stage, each resonant tank comprising a resonant capacitor in series with the primary side winding for that bridge converter leg, the method comprising: applying an AC input voltage to the bridge converter legs of the power stage; operating the bridge converter legs of the power stage at a switching frequency; and selecting the switching frequency such that a resonant frequency of each resonant tank is tuned to within +/−50% of the switching frequency.

Example 24. A multi-phase resonant power converter, comprising: a plurality of primary-side bridge converter legs on a primary side of the multi-phase resonant power converter, each primary-side bridge converter leg configured to receive an AC input voltage and implement a separate phase of the multi-phase resonant power converter; a plurality of secondary-side bridge converter legs on a secondary side of the multi-phase resonant power converter, each secondary-side bridge converter leg configured to implement a separate phase of the multi-phase resonant power converter; a transformer device having a primary side winding for each primary-side bridge converter leg and a secondary side winding for each secondary-side bridge converter leg; at least one controller configured to operate the secondary-side bridge converter legs and the primary-side bridge converter legs at a switching frequency; and a separate resonant tank electrically connected to a midpoint of each secondary-side bridge converter leg, each resonant tank comprising a resonant capacitor in series with the secondary side winding for that secondary-side bridge converter leg, wherein a resonant frequency of each resonant tank is tuned to within +/−50% of the switching frequency.

Example 25. The multi-phase resonant power converter of claim 24, further comprising: a separate low-frequency AC blocking capacitor electrically connected to a midpoint of each primary-side bridge converter leg and in series with the primary side winding for that primary-side bridge converter leg, wherein the low-frequency AC blocking capacitors are not tuned to the resonant frequency of the resonant tanks on the secondary side.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to include all possible conjunctive and disjunctive combinations, unless expressly noted otherwise. For example, the expression “A and/or B” should be interpreted to mean only A, only B, or both A and B. The expression “at least one of” should be interpreted in the same manner as “and/or”, unless expressly noted otherwise. For example, the expression “at least one of A and B” should be interpreted to mean only A, only B, or both A and B.

It is to be understood that the features of the various embodiments described herein can be combined with each other, unless specifically noted otherwise.

Although specific embodiments have been illustrated and described herein, it will be appreciated by those of ordinary skill in the art that a variety of alternate and/or equivalent implementations can be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A multi-phase resonant power converter, comprising:
a power stage on a primary side of the multi-phase resonant power converter, the power stage comprising a plurality of bridge converter legs each configured to receive an AC input voltage and implement a separate phase of the multi-phase resonant power converter;
a transformer device having a primary side winding for each bridge converter leg of the power stage, and a secondary side winding for each primary side winding;
a power circuit electrically connected to the secondary side windings of the transformer device on a secondary side of the multi-phase resonant power converter;
a primary-side controller configured to operate the bridge converter legs of the power stage at a switching frequency; and
a separate resonant tank electrically connected to a midpoint of each bridge converter leg of the power stage, each resonant tank comprising a resonant capacitor in series with the primary side winding for that bridge converter leg,
wherein a resonant frequency of each resonant tank is tuned to within +/−50% of the switching frequency.

2. The multi-phase resonant power converter of claim 1, wherein each bridge converter leg of the power stage comprises a plurality of switch devices, and wherein the primary-side controller is configured to operate the switch devices at a constant switching frequency between a voltage space vector in phase with a voltage space vector of the AC input voltage and a voltage space vector that is shifted 180° from the voltage space vector of the AC input voltage.

3. The multi-phase resonant power converter of claim 2, wherein a secondary-side controller is configured to control the power circuit by space-vector modulation to apply a voltage on the secondary side, such that power is driven through one or more of the resonant tanks on the primary side in each positive and negative primary-side half-switching period of the power stage.

4. The multi-phase resonant power converter of claim 3, wherein the secondary-side controller is configured to adjust a voltage vector applied on the secondary side by the space-vector modulation, to control power flow on the secondary side.

5. The multi-phase resonant power converter of claim 1, wherein the AC input voltage has a plurality of phases, wherein each bridge converter leg of the power stage is configured to receive a separate phase of the AC input voltage and comprises a single pair of bidirectional switch devices electrically connected in a half bridge configuration, and wherein the primary-side controller is configured to operate the bridge converter legs of the power stage in synchronization under PWM (pulse width modulation) control with 50% duty cycle.

6. The multi-phase resonant power converter of claim 1, wherein the AC input voltage has a plurality of phases, wherein each bridge converter leg of the power stage is configured to receive a separate phase of the AC input voltage and comprises two pairs of bidirectional switch devices electrically connected in a full bridge configuration, and wherein the primary-side controller is configured to operate the bridge converter legs of the power stage in synchronization under PWM (pulse width modulation) control with 50% duty cycle.

7. The multi-phase resonant power converter of claim 1, wherein the AC input voltage has a plurality of phases, wherein each bridge converter leg of the power stage is configured to receive a separate phase of the AC input voltage and comprises a single pair of power switch devices having unidirectional voltage blocking capability and electrically connected in a half bridge configuration or two pairs of power switch devices having unidirectional voltage blocking capability and electrically connected in a full bridge configuration, wherein the multi-phase resonant power converter has P phases and P is a positive integer greater than or equal to 2, and wherein the primary-side controller is configured to operate the bridge converter legs of the power stage in synchronization under PWM (pulse width modulation) control with 50% duty cycle.

8. The multi-phase resonant power converter of claim 1, wherein the AC input voltage has a single phase, wherein the bridge converter legs of the power stage are in parallel with one another and configured to receive the single-phase of the AC input voltage, wherein the multi-phase resonant power converter has P phases and P is a positive integer greater than or equal to 1, and wherein the primary-side controller is configured to operate the bridge converter legs of the power stage with a 360°/P phase shift under PWM (pulse width modulation) control with 50% duty cycle.

9. The multi-phase resonant power converter of claim 8, wherein each bridge converter leg of the power stage comprises a single pair of bidirectional switch devices electrically connected in a half bridge configuration or two pairs of bidirectional switch devices electrically connected in a full bridge configuration.

10. The multi-phase resonant power converter of claim 1, wherein each bridge converter leg of the power stage is a half bridge converter leg comprising:
an actively controlled leg formed by two power switch devices electrically connected in series at the midpoint of the bridge converter leg; and
a capacitive leg in parallel with the actively controlled leg.

11. The multi-phase resonant power converter of claim 1, wherein the primary-side controller is configured to operate the power stage in a boost mode by applying PWM (pulse width modulation) signals to the bridge converter legs of the power stage without pulse skipping, such that no resonant power transfer periods are skipped and the power circuit outputs a DC voltage that is larger than a line-to-line voltage of the transformer device on the secondary side.

12. The multi-phase resonant power converter of claim 1, wherein the primary-side controller is configured to operate the power stage in a buck mode by applying PWM (pulse width modulation) signals to the bridge converter legs of the power stage with pulse skipping, such that an integer number of resonant power transfer periods are periodically skipped and the power circuit outputs a DC voltage that is lower than a line-to-line voltage of the transformer device on the secondary side.

13. The multi-phase resonant power converter of claim 1, wherein the power circuit comprises an actively switched half or full bridge rectification leg for each phase of the multi-phase resonant power converter, and wherein a secondary-side controller is configured to control the actively switched half or full bridge rectification legs of the power circuit by space-vector modulation such that quasi-resonant currents flow in the primary side windings and the secondary side windings of the transformer device.

14. The multi-phase resonant power converter of claim 1, wherein the power circuit is a diode rectifier, wherein the multi-phase resonant power converter has P phases and P is a positive integer greater than or equal to 2, and wherein the primary-side controller is configured to operate the bridge converter legs of the power stage with a 360°/P phase shift under PWM (pulse width modulation) control with 50% duty cycle.

15. The multi-phase resonant power converter of claim 1, wherein the power circuit is a diode rectifier, and wherein the primary-side controller is configured to operate the bridge converter legs of the power stage with pulse skipping to control a DC output of the power circuit.

16. The multi-phase resonant power converter of claim 1, wherein the multi-phase resonant power converter has P phases and P is a positive integer greater than or equal to 2, and wherein the power circuit comprises M half or full bridge rectification legs and M is a positive integer greater than or equal to P+1.

17. The multi-phase resonant power converter of claim 1, wherein each bridge converter leg of the power stage comprises a single pair of switch devices electrically connected in a half bridge configuration or two pairs of switch devices electrically connected in a full bridge configuration, and wherein for each bridge converter leg of the power stage, a voltage rating of each switch device included in the bridge converter leg of the power stage is defined by a phase-to-neutral voltage of the AC input voltage.

18. The multi-phase resonant power converter of claim 1, wherein the primary side windings and the secondary side windings of the transformer device are integrated with a single magnetic structure.

19. The multi-phase resonant power converter of claim 18, wherein the single magnetic structure has a magnetic leg for each phase of the power converter, and wherein for each phase of the power converter, the primary winding and the secondary winding of the transformer device is wound on the same magnetic leg.

20. The multi-phase resonant power converter of claim 18, wherein the single magnetic structure has at least one additional magnetic leg for adjusting leakage flux of the transformer device and thus the resonant frequency of the resonant tank.

21. The multi-phase resonant power converter of claim 1, wherein the power circuit comprises a separate half or full bridge rectification leg for each phase of the power stage, wherein the bridge converter legs of the power stage are connected to the primary side windings of the transformer device in a Y-configuration or a delta-configuration, and wherein the half or full bridge rectification legs of the power circuit are connected to the secondary side windings of the transformer device in a Y-configuration or a delta-configuration.

22. The multi-phase resonant power converter of claim 1, wherein the power circuit comprises a separate half or full bridge rectification leg for each phase of the power stage, wherein the half or full bridge rectification legs are electrically connected in parallel to form a single DC output of the power circuit, and wherein the primary side windings and the secondary side windings of the transformer device are integrated with a single magnetic structure.

23. A method of operating a multi-phase resonant power converter that includes a power stage on a primary side of the multi-phase resonant power converter, the power stage comprising a plurality of bridge converter legs each configured to implement a separate phase of the multi-phase resonant power converter, a transformer device having a primary side winding for each bridge converter leg of the power stage and a secondary side winding for each primary side winding, a power circuit electrically connected to the secondary side windings of the transformer device on a secondary side of the multi-phase resonant power converter, and a separate resonant tank electrically connected to a midpoint of each bridge converter leg of the power stage, each resonant tank comprising a resonant capacitor in series with the primary side winding for that bridge converter leg, the method comprising:
applying an AC input voltage to the bridge converter legs of the power stage;
operating the bridge converter legs of the power stage at a switching frequency; and
selecting the switching frequency such that a resonant frequency of each resonant tank is tuned to within +/−50% of the switching frequency.

24. A multi-phase resonant power converter, comprising:
a plurality of primary-side bridge converter legs on a primary side of the multi-phase resonant power converter, each primary-side bridge converter leg configured to receive an AC input voltage and implement a separate phase of the multi-phase resonant power converter;
a plurality of secondary-side bridge converter legs on a secondary side of the multi-phase resonant power converter, each secondary-side bridge converter leg configured to implement a separate phase of the multi-phase resonant power converter;
a transformer device having a primary side winding for each primary-side bridge converter leg and a secondary side winding for each secondary-side bridge converter leg;
at least one controller configured to operate the secondary-side bridge converter legs and the primary-side bridge converter legs at a switching frequency; and
a separate resonant tank electrically connected to a midpoint of each secondary-side bridge converter leg, each resonant tank comprising a resonant capacitor in series with the secondary side winding for that secondary-side bridge converter leg,
wherein a resonant frequency of each resonant tank is tuned to within +/−50% of the switching frequency.

25. The multi-phase resonant power converter of claim 24, further comprising:
a separate low-frequency AC blocking capacitor electrically connected to a midpoint of each primary-side bridge converter leg and in series with the primary side winding for that primary-side bridge converter leg,
wherein the low-frequency AC blocking capacitors are not tuned to the resonant frequency of the resonant tanks on the secondary side.
